(19) United States
(12) Patent Application Publication
(10) Pub. No.: US 2006/0008148 A1
(43) Pub. Date: Jan. 12, 2006

(54) Character recognition device and method

(75) Inventor: Naoki Mochizuki, Kaisei-machi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/171,202

(22) Filed: Jul. 1, 2005

(30) Foreign Application Priority Data
Jul. 6, 2004 (JP) 2004-199311

(51) Int. Cl. G06K 9/18; G06K 7/10

(52) U.S. Cl. 382/182; 382/321

(57) ABSTRACT

A character recognition device capable of performing accurate character recognition even when positions of characters change or adjacent characters contact or overlap each other. The device includes a character recognition image data creating unit for extracting character string image data from image data generated by using an imaging modality and repeatedly shifting the character string image in a character string direction one pixel by one pixel to create plural kinds of character string image data; and a character recognition processing unit for separating character images from each character string image to obtain character pattern data representing the separated character images, performing character recognition by using the obtained character pattern data, and calculating certainty factors based on an agreement rate of recognition results to determine a recognition result character string based on the certainty factors with respect to the plural kinds of character string image data.

### BACKGROUND OF THE INVENTION

1. Field of the Invention

The present invention relates to a character recognition device and a character recognition method for performing character recognition based on image data representing images including character information inputted from an imaging modality (imaging device) for the purpose of diagnosis.

2. Description of a Related Art

Conventionally, various kinds of image data have been collected by imaging an object to be inspected such as a human body by using various kinds of modalities such as a CT (computed tomography) device, an MRI (magnetic resonance image) device, and a US (ultrasonography) device. For example, in the case of using a CT device, plural pieces of image data corresponding to ten to several hundreds of images are generated for one imaging, and then, they are collected. These pieces of image data are subjected to suitable processing and stored in an image storage device, displayed on an image display device such as a CRT, or outputted onto films or the like in a printer.

Furthermore, image data representing one or more images is retrieved from the image storage device, in which a series of image data has been stored, based on retrieval information. Based on the image data, the image display device displays an image of the object, or the printer outputs an image of the object onto a film or the like. As the retrieval information to be used for retrieval of image data, generally, patient information such as patient ID, patient name in Kanji (Chinese characters), patient name in alphabetic characters or the like, sex and date of birth, and examination information such as examination ID are used and the image data are stored in association with the information. The information is normally included in images at the time of imaging, and formed by characters such as kanji, hiragana (the rounded Japanese phonetic syllabary), alphabetic characters, numeric characters and signs.

By the way, as a technique of recognizing characters from image data representing images including character information, there is known a technique called template matching by which a character recognition dictionary (conversion table for character recognition), which has stored each template as a candidate character of the respective character to be recognized, is prepared with respect to each imaging modality, and a character included in an image is compared with the template so as to recognize the character.

Such a technique of template matching is used in an image input and output device for inputting image data from various kinds of imaging modalities, recognizing patient information and examination information from characters included in images, and outputting the image data along with the information as character data associated with the image data to the image storage device, image display device or printer.

According to such a technique of template matching, when a character string image exists in a fixed position at the left end or right end of the image such as in the case of patient information, there is no problem in designating the cutout of character string image by using fixed coordinates. However, for example, in the case where lateral blurring of character string image occurs at the time of analog capture or the position of character string image changes due to difference in number of characters by centering of character string image, if the cutout of character string image is designated by using fixed coordinates, there is a problem that the character string image can not be cutout appropriately and character recognition can not be performed accurately.

Further, depending on the imaging modality, sometimes adjacent character images contact or overlap in a character string image, and in such a case, the character images can not be separated by the space between the character images and how to separate character images appropriately becomes a problem.

Japanese Patent Application Publication JP-A-8-185485 discloses character recognition method and device for recognizing characters and words by allowing character cutout errors and word detection errors, in which item classification can be automatically corrected with accuracy even when character strings have narrow character spacing lengths and word spacing lengths, character types can be determined even when items are not registered in a keyword dictionary, and capacity of keyword dictionary and word dictionary can be reduced (paragraphs 0041 and 0074, and FIG. 6). According to the character recognition method and device, at the word detection step, words are detected by adopting an end of the first peak from the smallest value of the character spacing length in a histogram as a threshold value to be used in finding a break between words, and thereby, words can be accurately detected even when character strings have narrow character spacing lengths and word spacing lengths. However, in the character recognition method and device, the break between words is found from the histogram of character spacing lengths, and therefore, a step of creating the histogram of character spacing lengths is required. Further, JP-A-8-185485 does not disclose how to perform character recognition in the case where adjacent characters contact or overlap each other in a character string.

Further, Japanese Patent Application Publication JP-A-11-88589 discloses image processing device and method for supplying images obtained from an image diagnostic device to a computer network (paragraphs 0040 and 0041, FIG. 7). According to the image processing device and method, character information (patient name, patient ID, etc.) added to diagnostic images is recognized by labeling continuous areas of the extracted character patterns and obtaining feature amounts (the maximum value, an average value, a standard deviation value, etc. of the pixel values) with respect to each labeled continuous area to separate character images. However, the separation processing of character images is performed based on the limitation that character images never share one pixel with each other, and therefore, characters can not be recognized in the case where adjacent characters contact or overlap each other in a character string.

### SUMMARY OF THE INVENTION

The present invention has been achieved in view of the above-described problems. An object of the present invention is to provide a character recognition device and a character recognition method capable of performing accurate character recognition based on image data representing images including character information inputted from an imaging modality even when positions of character string images change or adjacent character images contact or overlap each other in a character string image.

In order to solve the above-described problems, a character recognition device according to one aspect of the present invention is a character recognition device for performing character recognition based on image data representing images including character information inputted from an imaging modality for a purpose of diagnosis, and comprises: character recognition image data creating means for extracting character string image data representing a character string image from image data generated by using the imaging modality and repeatedly shifting the character string image represented by the extracted character string image data in a character string direction at least one pixel by one pixel so as to create plural kinds of character string image data including the extracted character string image data; and character recognition processing means for separating character images from each character string image represented by the plural kinds of character string image data to obtain character pattern data representing the separated character images, performing character recognition by using the obtained character pattern data, and calculating certainty factors based on an agreement rate of recognition results of the character pattern data to determine a recognition result character string based on the certainty factors with respect to the plural kinds of character string image data.

Further, a character recognition method according to one aspect of the present invention is a character recognition method of performing character recognition based on image data representing images including character information inputted from an imaging modality for a purpose of diagnosis, and comprises the steps of: (a) extracting character string image data representing a character string image from image data generated by using the imaging modality and repeatedly shifting the character string image represented by the extracted character string image data in a character string direction at least one pixel by one pixel so as to create plural kinds of character string image data including the extracted character string image data; and (b) separating character images from each character string image represented by the plural kinds of character string image data to obtain character pattern data representing the separated character images, and performing character recognition by using the obtained character pattern data; and (c) calculating certainty factors based on an agreement of recognition results of the character pattern data to determine a recognition result character string based on the certainty factors with respect to the plural kinds of character string image data.

According to the present invention, accurate character recognition can be performed based on image data representing images including character information inputted from an imaging modality even when positions of character string images change or adjacent character images contact or overlap each other in a character string image.

### BRIEF DESCRIPTION OF THE DRAWINGS

FIG. 1 is a block diagram showing the constitution of a character recognition device according to one embodiment of the present invention;

FIGS. 2A to 2D show examples of character pattern data and character pattern data with lacking ends registered in a storage unit 18 as shown in FIG. 1;

FIG. 3 shows an example in which adjacent character images overlap each other;

FIG. 4 shows an example of created character string group image data in which extracted character string image data and plural character string image data formed by shifting pixels of the extracted character string image data one by one are sequentially arranged in the vertical direction;

FIG. 5 shows an example of image data for character recognition created by a character recognition image data generating unit 16 as shown in FIG. 1;

FIG. 6 is a flowchart showing the operation of the character recognition device 1 as shown in FIG. 1;

FIG. 7 shows an example of character string image data included in the image data that has been stored in an image data memory unit 15 as shown in FIG. 1;

FIG. 8 shows an example of image for character recognition 51 created by the character recognition image data creating unit 16 as shown in FIG. 1; and

FIG. 9 shows an example of recognition result character strings and certainty factors with respect to the image for character recognition 51 as shown in FIG. 8.

### DESCRIPTION OF THE PREFERRED EMBODIMENTS

Hereinafter, embodiments of the present invention will be described in detail by referring to the drawings.

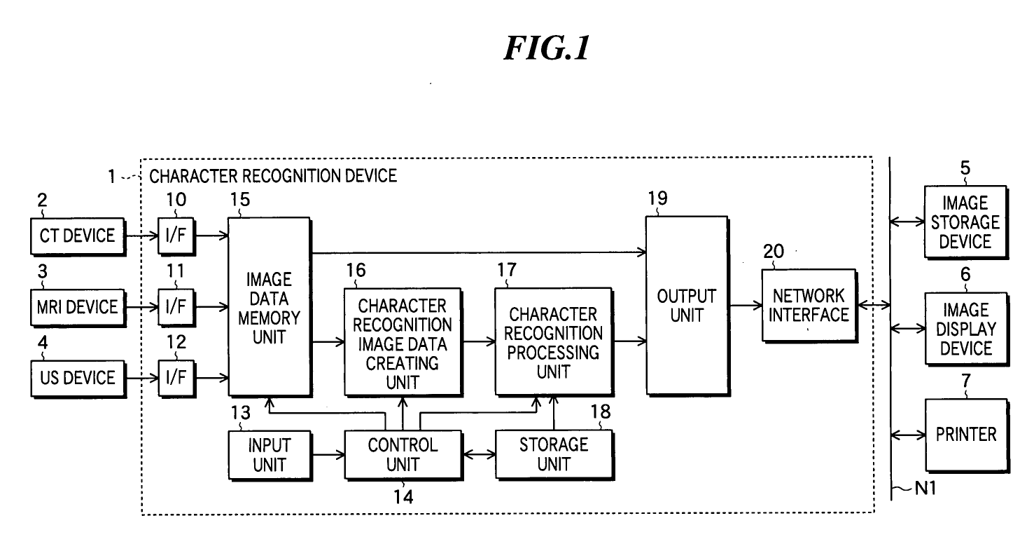

FIG. 1 is a block diagram showing the constitution of a character recognition device according to one embodiment of the present invention. A character recognition device 1 includes interfaces (I/Fs) 10 to 12, an input unit 13, a control unit 14, an image data memory unit 15, a character recognition image data creating unit 16, a character recognition processing unit 17, a storage unit 18, an output unit 19 and a network interface 20.

The interface 10 outputs image data inputted from a CT device 2 connected to the character recognition device 1 to the image data memory unit 15. The interface 11 outputs image data inputted from an MRI device 3 connected to the character recognition device 1 to the image data memory unit 15. The interface 12 outputs image data inputted from a US device 4 connected to the character recognition device 1 to the image data memory unit 15.

The control unit 14 controls the image data memory unit 15, the character recognition image data creating unit 16, the character recognition processing unit 17, and the storage unit 18 based on various kinds of instructions and information (e.g., a device name of the imaging modality, a character width, a character height, a number of overlapping lines, etc.) inputted from the input unit 13 (e.g., a keyboard or the like).

The image data memory unit 15 classifies image data inputted from the CT device 2, the MRI device 3 and the US device 4 via the interfaces 10 to 12 with respect to each device and stores them according to the control signals from the control unit 14.

The character recognition image data creating unit 16 reads out the image data from the image data memory unit 15 and cuts out character string image data, which represents character information included in the read image data, from a predetermined cutout position according to the control signals from the control unit 14, thereby extracts character string image data from the image data.

Further, in the case where adjacent character images overlap each other in the lateral direction (in the character string direction) by one pixel (a number of overlapping line (s)=1), for example, the character recognition image data creating unit 16 creates image data for character recognition in the following manner.

At least n1 kinds of character string image data are created by shifting extracted character string image data one by one pixel in the lateral direction (in the character string direction) where n1=(a number of pixels of the character image in the lateral direction)−2, and character string group image data is created in which the extracted character string image data and the created at least n1 kinds of character string image data are arranged in the vertical direction (in the direction different from the character string direction).

Then, a position where a character color first appears (hereinafter, referred to as “character color start position”) is detected in the extracted character string image data and the created character string image data included in the created character string group image data, and vertical lines in the same color as the background color (different color from the character color) are drawn within the character string images represented by the extracted character string image data and the created character string image data included in the created character string group image data at the pixel corresponding to the detected character color start position and every n2 of pixels from the character color start position where n2=(a number of pixels of the character image in the lateral direction)−1. Hereinafter, the extracted character string image data and the created character string image data in which vertical lines are drawn are referred to as “character string image data with vertical lines”.

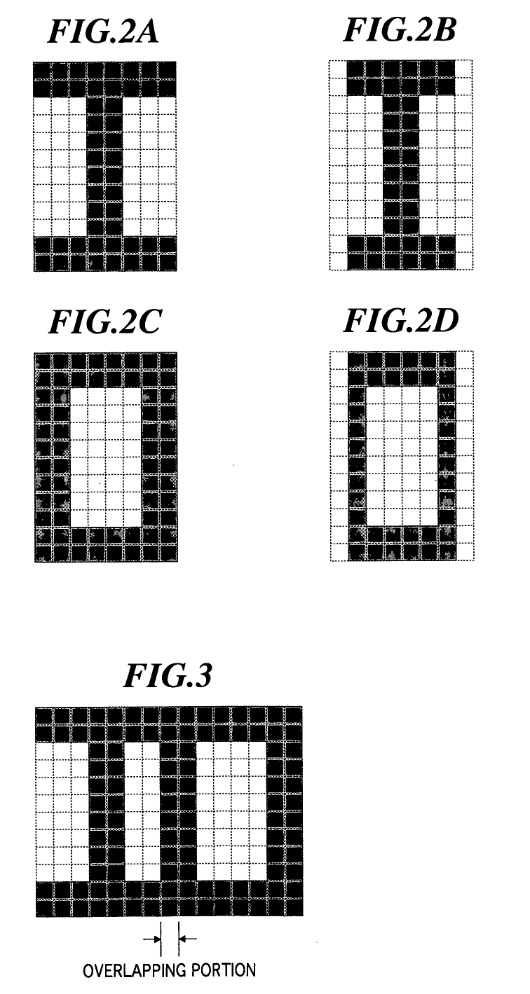

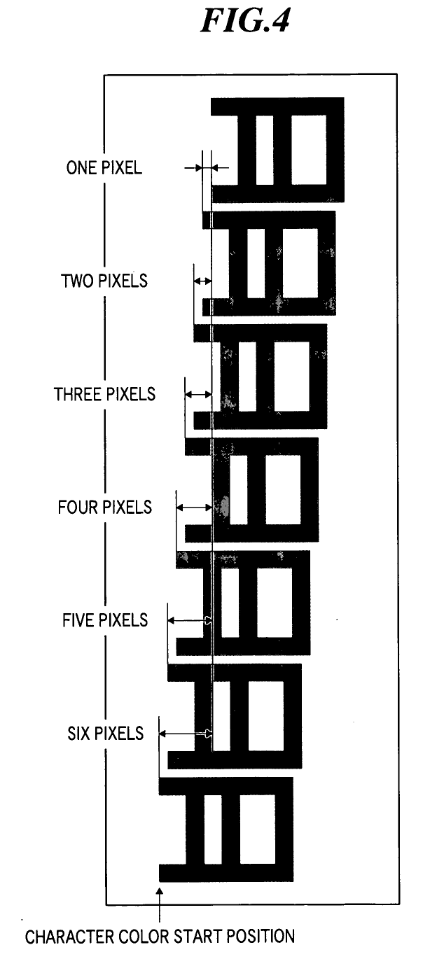

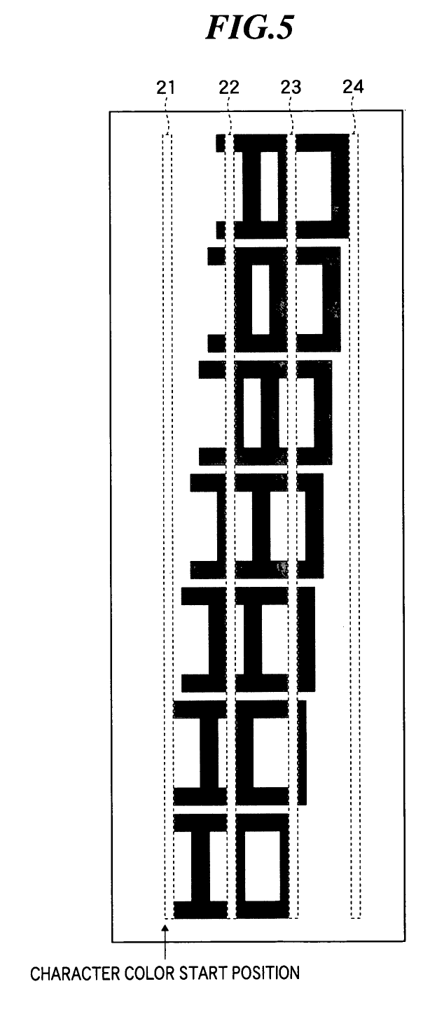

For example, in the case where character string image data in which the character image “I” of vertical 12 pixels×lateral 8 pixels as shown in FIG. 2A and the character image “O” of vertical 12 pixels×lateral 8 pixels as shown in FIG. 2C overlap with each other by one pixel as shown in FIG. 3 is extracted, the character recognition image data generating unit 16 arranges the extracted character string image as shown at the top of FIG. 4, and thereunder, a character string image formed by shifting the extracted character string image in the lateral direction (to the left in the drawing) by one pixel. Then, under the shifted character string image, the unit arranges a character string image formed by shifting the extracted character string image in the lateral direction (to the left in the drawing) by two pixels. The operation is repeated, and at the bottom, the unit arranges a character string image formed by shifting the extracted character string image in the lateral direction (to the left in the drawing) by six pixels. Thus, character string group image data representing a character string group image in which the extracted character string image and six character string images formed by shifting the pixel of the extracted character string image one by one are arranged in the vertical direction is created.

Then, the character recognition image data generating unit 16 detects a character color start position in the created character string group image. In the character string group image as shown in FIG. 4, the left end of the character string image at the bottom in the drawing is detected as the character color start position. Then, as shown in FIG. 5, the character recognition image data generating unit 16 creates image data for character recognition by drawing vertical lines 21 to 24 in the same color as the background color (shown by broken lines in the drawing) within the character string images represented by the character string group image data at the pixel in the detected character color start position and every n2 pixels from the character color start position where n2=(a number of pixels in the lateral direction of character images)−1.

In the storage unit 18 (e.g., a hard disk or the like), there is stored a character recognition dictionary to be used for character recognition processing in the character recognition processing unit 17. In the character recognition dictionary, besides the character pattern data (bitmap data) representing character images, character pattern data in which the character color in two vertical lines each having a width of one pixel at both ends of a character image represented by the character pattern data has been turned in the background color (hereinafter, referred to as “character pattern data with lacking ends”) is registered.

For example, as to the character image “I” as shown in FIG. 2A, besides the character pattern data of vertical 12 pixels×lateral 8 pixels as shown in FIG. 2A, the character pattern data with lacking ends of vertical 12 pixels×lateral 6 pixels as shown in FIG. 2B is registered in the character recognition dictionary. Similarly, as to the character image “O” as shown in FIG. 2C, besides the character pattern data of vertical 12 pixels×lateral 8 pixels as shown in FIG. 2C, the character pattern data with lacking ends of vertical 12 pixels×lateral 6 pixels as shown in FIG. 2D is registered in the character recognition dictionary.

According to the control signals from the control unit 14, the character recognition processing unit 17 separates character images by utilizing the vertical lines in the character string images represented by plural kinds of character string image data with vertical lines included in the image data for character recognition created by the character recognition image data creating unit 16 so as to obtain character pattern data representing the separated character images. Then, the character recognition processing unit 17 performs character recognition by using the obtained character pattern data while referring to the character recognition dictionary stored in the storage unit 18.

For example, as to the character string image with vertical lines as shown at the bottom of FIG. 5, the character recognition processing unit 17 separates the character images every seven pixels in the lateral direction from the character color start position by utilizing the vertical lines 21 and 22, and thereby, obtains character pattern data representing the separated character images, i.e., character pattern data representing the character image “I” on the left in the drawing, both ends of which have been turned in the background color by the vertical lines 21 and 22, and character pattern data representing the character image “O” on the left in the drawing, both ends of which have been turned in the background color by the vertical lines 22 and 23, in the character string image represented by the character string image data with vertical lines. Then, the character recognition processing unit 17 performs character recognition by using the obtained character pattern data representing the character image “I” and the obtained character pattern data representing the character image “O” and referring to the character recognition dictionary stored in the storage unit 18. Here, the character recognition processing unit 17 performs character recognition by referring to the character pattern data with lacking ends in which the color in two vertical lines each having a width of one pixel at both ends of the character pattern image is turned in the background color as shown in FIGS. 2B and 2D from among the character pattern data registered in the character recognition dictionary.

Then, the character recognition processing unit 17 calculates certainty factors based on an agreement rate of the recognition results of character pattern data and calculates average values of the certainty factors with respect to the plural kinds of character string image data with vertical lines, and determines the recognition result (recognition result character string) of character string image data with vertical lines having the largest average value of the certainty factors as a final recognition result.

The output unit 19 outputs the recognition result character string recognized in the character recognition processing unit 17 with the image data stored in the image data memory unit 15 or singly through the network interface 20 connected to an image storage device 5, an image display device 6 and a printer 7 via a network N1 to one or more of the devices 5 to 7.

Here, the control unit 14, the character recognition image data creating unit 16 and the character recognition processing unit 17 may be formed by a CPU and software (control program), or formed by a digital circuit or analog circuit. In the former case, the software (control program) may be stored in the storage unit 18 so that the CPU reads out the software from the storage unit 18.

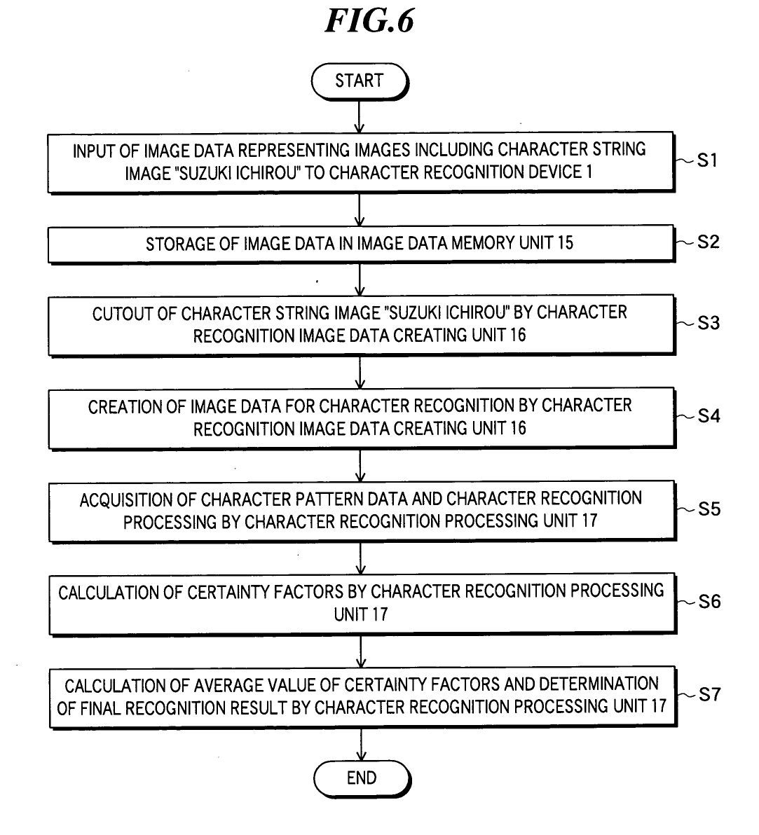

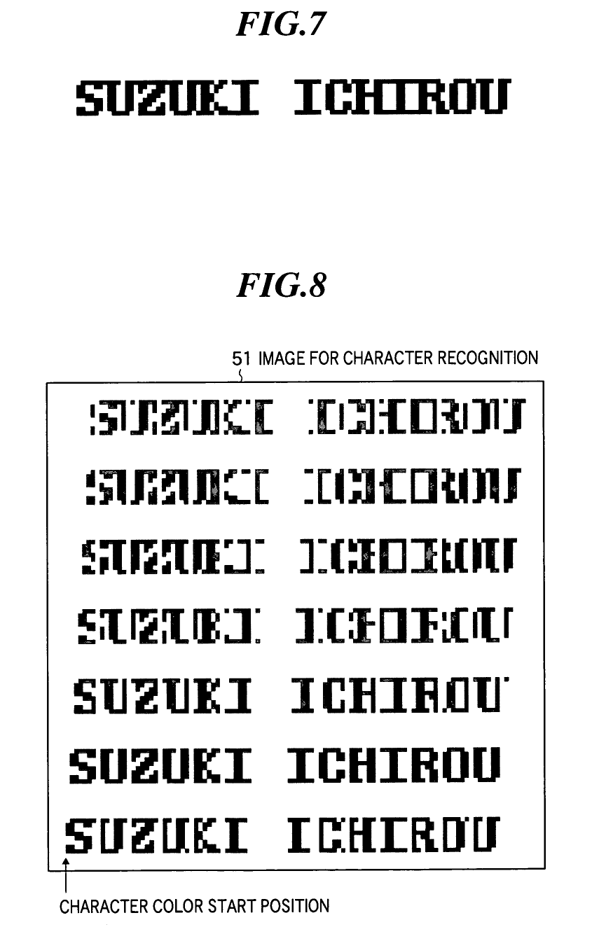

Next, the operation of the character recognition device 1 according to the embodiment will be described by referring to FIGS. 6 to 9. FIG. 6 is a flowchart showing the operation of the character recognition device 1 as shown in FIG. 1. FIG. 7 shows an example of character string image included in the image represented by the image data that has been stored in the image data memory unit 15 as shown in FIG. 1. FIG. 8 shows an example of character string image with vertical lines represented by the image data for character recognition created by the character recognition image data creating unit 16 as shown in FIG. 1.

First, at step S1 in FIG. 6, image data representing the image including the character string image “SUZUKI ICHIROU” as shown in FIG. 7 is inputted from the CT device 2, the MRI device 3 or the US device 4 to the character recognition device 1 and inputted to the image data memory unit 15 via corresponding one of the interfaces 10 to 12.

Then, at step S2, an operator inputs device information representing the device (imaging modality), that has outputted the image data, to the control unit 14 by using the input unit 13. For example, when the CT device 2 outputs the image data, the operator inputs the device information representing the CT device 2 to the control unit 14 by using the input unit 13.

The control unit 14 outputs control signals including the device information to the image data memory unit 15 for registration. The image data memory unit 15 classifies and stores the image data with respect to each device based on the device information.

At step S3, according to the control signals from the control unit 14, the character recognition image data creating unit 16 reads out the image data representing the image including the character string image “SUZUKI ICHIROU” from the image data memory unit 15, and then, cuts out the character string image “SUZUKI ICHIROU” represented by the read image data from a predetermined cutout position (e.g., the right end of the image) so as to extract character string image data from the image data.

At step S4, the character recognition image data creating unit 16 creates an image for character recognition 51 as shown in FIG. 8 by using the extracted character string image data in the following manner.

A character string image formed by shifting the extracted character string image to the left in the drawing by one pixel is arranged under the extracted character string image. A character string image formed by shifting the extracted character string image to the left in the drawing by two pixels is arranged under the shifted character string image. Similarly, character string images formed by shifting pixels of the extracted character string image one by one are sequentially arranged in the lateral direction, and at the bottom, there is arranged a character string image formed by shifting the extracted character string image to the left in the drawing by six pixels, which corresponds to (a number of pixels in the lateral direction of character images)−2. Thereby, character string group image data representing a character string group image is created, in which the extracted character string image and six character string images formed by shifting the pixels of the extracted character string image one by one to the left in the drawing are arranged in the vertical direction.

Then, the character recognition image data generating unit 16 detects a character color start position in the created character string group image, and draws vertical lines in the same color as the background color in the character string group image on a pixel at the detected character color start position and every seven pixels from the character color start position. Thereby, the image for character recognition 51 representing the total seven character string image data with vertical lines is created.

At step S5, according to the control signals from the control unit 14, the character recognition processing unit 17 separates character images every seven pixels in the lateral direction by utilizing the vertical lines and obtains character pattern data representing the character images to be character-recognized, i.e., character pattern data corresponding to “S”, “U”, “Z”, “U”, “K”, “I”, “I”, “C”, “H”, “I”, “R”, “O” and “U” from the character string image with vertical lines which are arranged from the top of FIG. 8 to the bottom of FIG. 8 and represented by the image data for character recognition inputted from the character recognition image data creating unit 16.

Then, the character recognition processing unit 17 performs character recognition by using the obtained character pattern data while referring to the character recognition dictionary stored in the storage unit 18. Here, the character recognition processing unit 17 performs character recognition by referring to the character pattern data with lacking ends in which the color in two vertical lines each having a width of two pixels at both ends of the character pattern data is turned in the background color as shown in FIGS. 2B and 2D from among the character pattern data registered in the character recognition dictionary.

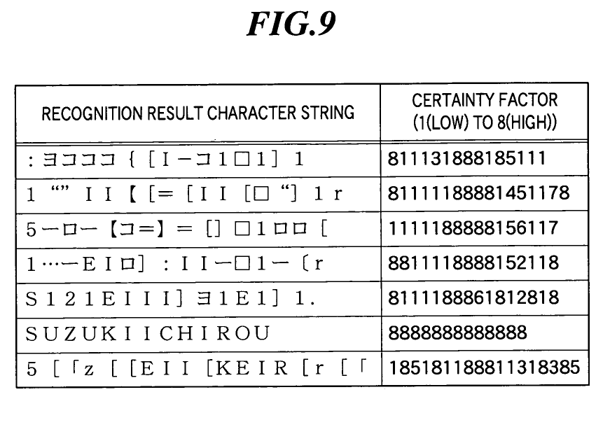

At step S6, the character recognition processing unit 17 calculates certainty factors based on an agreement rate of the recognition results of respective character pattern data. FIG. 9 shows an example of recognition result character strings and certainty factors including “1” (low) to “8” (high) with respect to the image for character recognition 51 as shown in FIG. 8. The recognition result character strings in the respective rows in FIG. 9 show recognition results with respect to character string images with vertical lines as shown in from the top to the bottom of the image for character recognition 51 in FIG. 8. In the real output, the result character string is obtained as one character string segmented by “\r\n”.

At step S7, the character recognition processing unit 17 calculates average values of the certainty factors with respect to character string images with vertical lines, and determines the recognition result character string, which is the recognition result of the character string image with vertical lines having the largest average value of the certainty factors, as a final recognition result. In the example as shown in FIG. 9, since the average of the certainty factors of the second recognition result character string “SUZUKI ICHIROU” from the bottom becomes “8” that is the largest, the character recognition processing unit 17 determines the recognition result character string “SUZUKI ICHIROU” as a final recognition result.

By the way, although the character recognition processing unit 17 obtains the final recognition result by calculating an average value of the certainty factors with respect to each character string image with vertical lines in the embodiment, the final recognition result may be obtained by one of the following methods.
(1) calculating a sum or variance of the certainty factors.
(2) setting a threshold value (since all certainty factors of correct recognition results are expected to be high, inappropriate results are eliminated by rejecting results in which at least one certainty factor equal to or less than “5” occurs).
(3) restricting a number of characters (a number of places of patient ID, etc. is often fixed according to the use environment, and can be determined by providing the number of characters as a parameter in advance).
(4) restricting character types (personal names can be filtered by a restriction that the use other than alphabet is forbidden or the like).
(5) combining conditions (the accuracy is raised by combining the above-described conditions such that “an average value of the certainty factors is large and variance of the certainty factors is small” or “a number of characters is within a predetermined value and a sum of the certainty factors is the largest”).

In the above embodiments, the character recognition image data creating unit 16 collectively performs character recognition processing by using the image data for character recognition including the extracted character string image data and other plural pieces of character string image data. However, the character recognition processing may be performed step by step with respect to each piece of character string image data. That is, after the character recognition processing is performed by using the extracted character string image data, the processing of shifting the extracted character string image data by one pixel in the lateral direction and the character recognition processing using the shifted extracted character string image data may be repeated sequentially at predetermined times.

Further, in the case of an imaging modality specified such that the adjacent character images in the character string image representing character information can not contact and overlap each other, the character recognition processing unit 17 may perform character recognition by using the image data for character recognition including character string group image data representing an image in which the extracted character string image and other plural character string images formed by shifting the pixels of the extracted character string image one by one in the lateral direction are arranged in the vertical direction without creating character string image data with vertical lines. In this case, the character recognition processing unit 17 may separate character images from the character string image by using spaces between the character images to obtain character pattern data to be character-recognized. Further, character recognition may be performed not by referring to the character pattern data with lacking ends as shown in FIGS. 2B and 2D, but by referring to the character pattern data with both ends as shown in FIGS. 2A and 2C.

Furthermore, although the example has been described in the case where the number of overlapping lines is “1”, in the case where the number of pixels in the lateral direction of the character string image is “N” and the number of overlapping lines is “n” where “N” and “n” are integers larger than “1” and “N” is larger than “n”, the number of character string images required for creating image data for character recognition is (N-n), and the width and spacing of the vertical lines in the same color as the background color are n pixels and (N-n) pixels, respectively.

Further, although the CT device 2, the MRI device 3, and the US device 4 are locally connected respectively, they may be network-connected.

According to the character recognition device of the embodiment, since the character recognition is performed by using the image data for character recognition representing the character string group image in which the extracted character string image data and other plural character string images formed by shifting the pixels of the extracted character string image at least one by one in the lateral direction are arranged in the vertical direction, even in the case where lateral blurring of character string image occurs at the time of analog capture or the position of a character string image changes due to difference in number of characters by centering of the character string image or the like, character images can be appropriately separated from one kind of character string image data and character recognition can be performed accurately. Further, since character recognition is performed for plural character string images arranged as a character string group image, the overhead for calling up a character recognition processing program can be avoided in comparison with the case where the character recognition processing is performed with respect to each character string image. On the other hand, in the case where the character recognition processing is performed with respect to each character string image, a memory capacity required for one execution of the character recognition processing can be reduced.

Furthermore, since the vertical lines in the same color as the background color are drawn in each character string image included in the character string group image on the pixel at the detected character color start position and every predetermined number of pixels from the character color start position and the character pattern data with lacking ends is registered in the character recognition dictionary, even when the adjacent character images in the character string image overlap with each other, the character recognition can be performed accurately from the separated character images.

1. A character recognition device for performing character recognition based on image data representing images including character information inputted from an imaging modality for a purpose of diagnosis, said device comprising:
character recognition image data creating means for extracting character string image data representing a character string image from image data generated by using said imaging modality and repeatedly shifting the character string image represented by the extracted character string image data in a character string direction at least one pixel by one pixel so as to create plural kinds of character string image data including the extracted character string image data; and
character recognition processing means for separating character images from each character string image represented by the plural kinds of character string image data to obtain character pattern data representing the separated character images, performing character recognition by using the obtained character pattern data, and calculating certainty factors based on an agreement rate of recognition results of the character pattern data to determine a recognition result character string based on the certainty factors with respect to the plural kinds of character string image data.

2. A character recognition device according to claim 1, wherein:
said character recognition image data creating means creates image data for character recognition in which the character string images represented by the plural kinds of character string image data are arranged in a direction different from the character string direction; and
said character recognition processing means separates character images from each character string image represented by the plural kinds of character string image data included in the image data for character recognition to obtain character pattern data representing the separated character images, and performs character recognition by using the obtained character pattern data.

3. A character recognition device according to claim 1, wherein when each of the plural kinds of character string image data is created by said character recognition image data creating means, said character recognition processing means separates character images from the character string image represented by said character string image data to obtain character pattern data representing the separated character images, and performs character recognition by using the obtained character pattern data.

4. A character recognition device according to claim 1, wherein said character recognition image data creating means creates plural kinds of character string image data in which vertical lines are drawn in a different color from a character color within the character string images represented by the plural kinds of character string image data on a pixel at a start position of the character color and every predetermined number of pixels from the start position of the character color.

5. A character recognition device according to claim 4, wherein said character recognition processing means performs character recognition by referring to character pattern data in which a color of pixels included in two lines at both ends of character images has been turned in a different color from the character color.

6. A character recognition method of performing character recognition based on image data representing images including character information inputted from an imaging modality for a purpose of diagnosis, said method comprising the steps of:
(a) extracting character string image data representing a character string image from image data generated by using said imaging modality and repeatedly shifting the character string image represented by the extracted character string image data in a character string direction at least one pixel by one pixel so as to create plural kinds of character string image data including the extracted character string image data;
(b) separating character images from each character string image represented by the plural kinds of character string image data to obtain character pattern data representing the separated character images, and performing character recognition by using the obtained character pattern data; and
(c) calculating certainty factors based on an agreement rate of recognition results of the character pattern data to determine a recognition result character string based on the certainty factors with respect to the plural kinds of character string image data.

7. A character recognition method according to claim 6, wherein:
step (a) includes creating image data for character recognition in which the character string images represented by the plural kinds of character string image data are arranged in a direction different from the character string direction; and
step (b) includes separating character images from each character string image represented by the plural kinds of character string image data included in the image data for character recognition to obtain character pattern data representing the separated character images, and performing character recognition by using the obtained character pattern data.

8. A character recognition method according to claim 6, wherein when each of the plural kinds of character string image data is created at step (a), step (b) includes separating character images from the character string image represented by said character string image data to obtain character pattern data representing the separated character images, and performing character recognition by using the obtained character pattern data.

9. A character recognition method according to claim 6, wherein step (a) includes creating plural kinds of character string image data in which vertical lines are drawn in a different color from a character color within the character string images represented by the plural kinds of character string image data on a pixel at a start position of the character color and every predetermined number of pixels from the start position of the character color.

10. A character recognition method according to claim 9, wherein step (b) includes performing character recognition by referring to character pattern data in which a color of pixels included in two lines at both ends of character images has been turned in a different color from the character color.
